(19) United States
(12) Patent Application Publication
(10) Pub. No.: US 2012/0033826 A1
(43) Pub. Date: Feb. 9, 2012

(54) SPEAKER SYSTEM AND SOUND REPRODUCTION APPARATUS

(76) Inventor: JUN-ICHI KAKUMOTO, Tokushima City (JP)

(21) Appl. No.: 13/086,314

(22) Filed: Apr. 13, 2011

(30) Foreign Application Priority Data
Aug. 3, 2010 (JP) 2010-185560
Aug. 30, 2010 (JP) 2010-206088

(51) Int. Cl. H04R 1/02; H04B 1/00

(52) U.S. Cl. 381/86; 381/335; 381/333

(57) ABSTRACT

The present invention relates to low sound reproduction of a compact speaker, a degree of freedom of design for the low sound reproduction, chattering noise of structures of electronic apparatuses due to powerful low sound reproduction, chattering noise of structures near a car speaker due to powerful low sound reproduction, leakage of sound out of a vehicle, and an exterior design of unattractive passive radiators. Specifically, a bottom-raised box part is installed in an enclosure to adjust a volume of the enclosure. A plurality of pairs of passive radiators having different resonance conditions is installed. An external enclosure is installed in the outside of the speaker system including a driver, passive radiators and an enclosure. Signal processing is performed to {suppress a gain at a resonance point of the lowest frequency band providing the maximal vibration of the driver} and {emphasize a gain at a resonance point of the lowest frequency band providing the minimal vibration of the driver}.

### CROSS-REFERENCE TO RELATED APPLICATION

This application claims the benefit of Japanese Application No. 2010-185560, filed on Aug. 3, 2010, with the Japan Patent Office, the disclosure of which is incorporated herein by reference.

### BACKGROUND OF THE INVENTION

1. Field of the Invention

The present invention relates to a speaker system and a sound reproduction apparatus. More particularly, the present invention relates to, first, a technique for enhancing low sound reproduction capability of a compact speaker system and a compact sound reproduction apparatus, second, a technique for overcoming problems such as {chattering noise due to vibration of structures around a speaker}, {an adverse effect by vibration of a liquid crystal panel of an LCD TV on a picture} and so on in reproducing low sound, and, third, an {actual vibration effect and its theorem} of a {vibration mode of a compact speaker system having a passive radiator}.

2. Description of the Related Art

In recent years, earphones or players having an environmental noise reduction capability have been being sold. Such devices may be generally classified into an active type and a passive type. The present invention involves a passive type earphone.

### Definitions of Terms

Throughout the specification including the claims, technical terms indicated by {•} take precedence over other technical terms outside {•}. Technical terms defined in the claims are equally applied to the specification.

The present invention provides a vibration analysis of a sound vibration system {including a driver, a passive radiator, an enclosure structure and air}, and an external design of a {theorem and trial manufacture experience} speaker of an {effect on {a vibration mode of a resonance point of a speaker system} provided by dimensions of (driver design specifications, passive radiator design specifications and enclosure design specifications}}.

In general, a speaker is a constituent of an audio system which emits a sound into which an input current change is converted.

A conventional speaker includes an internal enclosure (or a cabinet) forming a body of a speaker system, and a driver which is formed in the front of the enclosure, and emits a sound into which a current received by the driver is converted. In the meantime, in order to improve a characteristic of an output sound or reinforce an insufficient low sound of a general speaker, a baffle board is formed within the internal enclosure to change the output sound. As an alternate, the insufficient low sound of the general speaker may be reinforced by emitting sound emitted into the internal enclosure through a duct communicating the inside of the internal enclosure to the outside of the internal closure.

In addition to the method of changing the structure of the internal enclosure as described above, a low sound output characteristic can be improved by placing one or more passive radiators within the internal enclosure, apart from the driving speaker.

A passive radiator refers to a passive resonant diaphragm, which vibrates according to a driver vibration received via internal air of the enclosure, thereby mainly emitting low sound energy.

When a speaker system having the passive radiator is equipped within a vehicle or the like, chattering noise may be likely to be produced due to vibration of structures around the speaker in low sound reproduction. In addition, when the speaker system is equipped within an LCD TV, a picture may be adversely affected by vibration of a liquid crystal panel of the TV.

In the meantime, if one or more passive radiators are quipped within the internal enclosure and are externally exposed, it may make an ill appearance. If the passive radiators are placed in the side of the internal enclosure, it may result in difficulty in mounting the speaker system on a vehicle or a TV.

Therefore, there is a need for development of a speaker which is capable of providing low sound reproduction capability and preventing generation of chattering noise even in a compact speaker system. In addition, there is another need for development of a speaker which makes a good appearance irrespective of installation of a plurality of passive radiators and is capable of effectively emitting forwardly output sound of the passive radiators.

### SUMMARY OF THE INVENTION

The current design for a speaker system has no conclusive measure to {solve the following first to fifth contradictory tasks}.

The first task is a {very high degree of freedom of design for low sound reproduction performance}.

The second task is {powerful low sound reproduction capability}.

The third task is {compactness and lightness}.

The fourth task is that a speaker system does not generate mechanical vibration and air vibration is not leaked {into an assembled apparatus}.

The fifth task is a very high degree of freedom of design for external appearance.

It is an object of the present invention to provide a compact speaker system with good low sound reproduction capability. It is another object of the present invention to provide an aesthetic speaker system in which an external enclosure prevents one or more sets of passive radiators installed in an internal enclosure from being directly exposed to the outside.

It is still another object of the present invention to provide a speaker system in which an external enclosure can emit output sound of one or more sets of passive radiators installed in an internal enclosure in the forward direction of the speaker and can prevent chattering noise of structures where the speaker is installed.

It is still another object of the present invention to provide a speaker system which can be manufactured into various shapes by allowing an external enclosure to surround one or more sets of passive radiators installed in an internal enclosure, and accordingly can be easily constructed in vehicles or TVs.

There exists no special solution to solve all of the first to fifth tasks. The present invention solves {the contradictory tasks with a relationship of trade-off} with various inventive solutions as will be outlined below. The following solutions are specific speaker system design methods which are extracted by {detecting vibration of various parts of the speaker system having passive radiators} through {a great number of trial manufactures}.

The first task is solved by the following plurality of 1-1, 1-2 and 1-3 solutions.

The 1-1 solution is a free design technique for resonance conditions of {first and second resonance points} which are {factors most important in providing high reproduction capability to the speaker system having passive radiators}.

The 1-2 solution is to use a bottom-raised box structure which can change a {volume of an internal enclosure} which is a {factor important in freely designing {first and second resonance points}} {without having an effect on other factors}.

The 1-3 solution is to install a plurality of {pairs of passive radiators having different resonance conditions} to allow more free {designs of first and second resonance points}. Typically, two pairs of passive radiators are sufficient.

For the {second and third} tasks, it is possible to design a {compact speaker system having powerful low sound reproduction capability} by the {1-1, 1-2 and 1-3} solutions to widen a degree of freedom of design.

For the fourth task, a fourth solution is to install an external enclosure for guide in the outside of an internal enclosure in order to {draw emission energy of passive radiators to a low sound radiating hole}.

For the fifth task, a fifth solution is a by-product of the fourth solution. With the fifth solution, the external enclosure covers the passive radiators and low sound is emitted from the front face of the speaker system, which results in elimination of a troublesome design task.

For the sixth task, a sixth solution can design {optimal signal processing required to suppress demerits and draw merits} through {theoretical apprehension of first and second resonance points} and {{phenomenal apprehension} of {merits and demerits} of a speaker system designed at first and second resonance points}.

It is difficult to achieve a {design of a speaker system having high capability} with only speaker professional skill. In addition, signal processing professional skill has only to deal with a given speaker system well.

The present invention solves several contradictory tasks by combining several solutions. However, these solutions {provide capability to a speaker system} but do not {improve a reproduction characteristic of the speaker system}. In many cases, {reproduction capability does not match a reproduction characteristic} and {efficient and simple signal processing environments are essential in evaluating reproduction capability required to show the maximal effect in combination of the speaker system with signal processing}.

That is, there is a need of {knowledge and technique} about both of {synthesis and analysis of vibration} and {synthesis and analysis of signal processing required to provide a good reproduction characteristic. {Consideration on signal processing required to approach an expected reproduction characteristic} clarifies optimal values of {more efficient design specification of a driver as an electro-acoustic converting function} and {design specification of a speaker system having passive radiators}. In addition, optimal dimensions described in an actual blue print can be determined by experiencing a {{repetition procedure of {trial manufacture-measurement-improvement} for each of a great number of actual samples}.

The present invention is made as a result of arrangement of design methods to make a speaker system through this repetitive experimental work.

The first spirit of the present invention involves a {design method to associate {main dimensions expressed in design specification} with {evaluation items of sound reproduction capability} as independently as possible}. A design for vibration system is exhaustive in {providing high reproduction capability to a vibration system} without being conscious of a sound reproduction characteristic. In addition, a finishing stage of sound reproduction characteristic is performed by signal processing. The signal processing does not adjust an ostensible sound characteristic but basically provides {demerit-suppression and merit-drawing capability} of the {speaker system of the present invention}.

The second spirit of the present invention involves a combination of {a plurality of methods concerning a structure of the speaker system} and {a plurality of methods concerning signal processing}, which may correspond to importance of {increase of the number of times of {design-trial manufacture-test} procedure by reducing a cycle of the procedure}.

The third spirit of the present invention involves a design method in which an exterior design is not affected by a {change of a {plurality of factors of a vibration system}}.

Here, the {plurality of methods concerning a structure of the speaker system} is as follows: The first is to use one or two sets of opposing passive radiators. The second is to install an external enclosure covering the passive radiators. The third is to emit low sound energy from a gap between the external enclosure and the internal enclosure. The fourth is to lessen a volume of an occupation space by making a shape of the external enclosure {octagonal, circular or elliptical}. The fifth is to adjust a volume of the internal enclosure using a bottom-raised box part. The sixth is to install two sets of passive radiators having different design specifications of {emission area and weight} and adjust resonance conditions, if necessary.

Here, the plurality of methods concerning signal processing is as follows: The first is to suppress a gain at a {resonance point at which a vibration amplitude of a driver is maximized}, which is one demerit of the speaker system of the present invention. The second is to emphasize a gain a {resonance point at which a vibration amplitude of a driver is minimized}, which is one merit of the speaker system of the present invention. In addition, if an amplitude after the signal processing is about to be beyond a dynamic range of signal processing capability due to this gain emphasis, the gain emphasis is automatically limited.

To accomplish the above objects of the present invention, according to an aspect of the invention, there is provided a speaker system including: at least one driver which converts input electrical energy into vibration energy and emits a sound wave; an internal enclosure in which the driver is installed in the front face and which forms a sealed space therein; at least one pairs of passive radiators which is installed perpendicular to an emission surface of the driver and is vibrated by the vibration energy output from the driver to emit a sound wave; and an external enclosure which forms a space in the front face of the passive radiators to cover the passive radiators and includes a low sound radiating hole formed in the front face of the internal enclosure such that a sound wave emitted from the passive radiators is guided to the front face of the internal enclosure through the formed space.

### Advantages of the Invention

A compact high performance speaker system having a high degree of freedom for {product planning and product design} can be realized.

The degree of freedom is as follows: The first is the definition of variable conditions required to easily realize a characteristic expected for a design of sound performance. The second is no consideration of chattering noise of parts of the system. The third is no dependency of {sound performance of an assembled speaker system} on a {structure of the speaker system}. The fourth is {reduction of finishing time} and {feasibility of estimate calculation of finishing time} of sound performance. The fifth is no need of deliberation on exterior design to hide unattractive passive radiators.

The compact high performance speaker system is as follows: The sixth is to design the speaker system such that a low sound reproduction frequency range of the speaker system is significantly wider than an inherent frequency range of a driver unit. The seventh is to design the speaker system such that the speaker system is significantly shorter or smaller than conventional speaker systems having the same low sound reproduction frequency range. The eighth is to standardize the speaker system as a part.

Accordingly, the present invention provides a compact high performance speaker system with diversified product manufactures and designs as follows:

1. In a design of sound performance, variable conditions required to easily realize an expected characteristic can be definitely set.

2. An effect of chattering noise of parts of the system can be eliminated.

3. Excellent sound performance can be exhibited irrespective of installation places and structures of the speaker system.

4. A schedule for improvement of sound performance can be reduced and a manufacturing schedule can be predicted.

5. There is no need of concern about exterior design to hide unattractive passive radiators.

6. In a design of compact high performance speaker system, it is possible to design the speaker system such that a low sound reproduction frequency range of the speaker system is significantly wider than an inherent frequency range of a driver unit.

7. It is possible to design the speaker system such that the speaker system is significantly shorter or smaller than conventional speaker systems having the same low sound reproduction frequency range.

8. It is possible to standardize the speaker system as a part.

### BRIEF DESCRIPTION OF THE DRAWINGS

FIG. 1 is a view showing a speaker system according to an embodiment of the present invention;

FIG. 2 is a view showing a speaker system according to an embodiment of the present invention;

FIG, 3 is a view showing a speaker system according to an embodiment of the present invention;

FIG. 4 is a view showing a speaker system according to an embodiment of the present invention;

FIG. 5 is a view showing a speaker system according to an embodiment of the present invention;

FIG. 6 is a view showing a speaker system according to an embodiment of the present invention;

FIG. 7 is a view showing a speaker system according to an embodiment of the present invention;

FIG. 8 is a view showing a speaker system according to an embodiment of the present invention;

FIG. 9 is a view showing a speaker system according to an embodiment of the present invention;

FIG. 10 is a graph showing a mechanical electrical frequency characteristic of a speaker system according to an embodiment of the present invention;

FIG. 11 is a graph showing a characteristic of an actual sample of a speaker system according to an embodiment of the present invention; and

FIG. 12 is a graph showing a characteristic of an actual sample of a speaker system according to an embodiment of the present invention.

### DETAILED DESCRIPTION OF THE PREFERRED EMBODIMENT

The present invention suggests a compact speaker system with good low sound reproduction capability. To this purpose, a driver is installed in the front face of an internal enclosure and a passive radiator is installed within the internal enclosure. In this case, according to the present invention, an external enclosure which defines and surrounds a space along with the passive radiator is provided in the front face of the passive radiator. By surrounding the passive radiator and forming a low sound radiating hole in the front face of the internal enclosure, the external enclosure guides a sound wave emitted from the passive radiator to be output in the front direction of the speaker system.

Thus, the passive radiator is covered by the external enclosure, thereby improving the beauty of the speaker system and enhancing low sound output capability of the speaker system, which may result in good low sound reproduction capability even in a compact speaker system.

In addition, when the speaker system of the present invention is installed in a vehicle or the like, chattering noise due to vibration of structures around the speaker can be prevented in reproducing low sound. In addition, when the speaker system is installed in an LCD TV, there occurs no problem of an adverse effect of vibration of a liquid crystal panel on pictures.

In the meantime, the speaker system according to the present invention may be modified in various ways to show an optimal sound reproduction capability depending on an installation place or structure.

For example, the low sound radiating hole of the external enclosure may be implemented to be formed in the left and right sides or top and bottom sides of the front face of the internal enclosure. In this case, the external enclosure may be separately attached to the outside of the internal enclosure or may be integrated with the internal enclosure.

In this manner, a combination of the external enclosure and the internal enclosure forms an external appearance of the speaker system and various shapes of speakers can be prepared depending on a shape of the internal enclosure or the external enclosure. Thus, it is possible to make an easy design of the speaker system having the same good low sound output characteristic and suitable for an installation place and structure. For example, the speaker system can be manufactured to have various shapes, including a cube, a cuboid having a vertical direction of the front face thereof a major axis, a cuboid having a horizontal direction of the front face thereof a major axis, a shape having an octagonal section of the front face thereof, a shape having a circular section of the front face thereof, a shape having an elliptical section of the front face thereof, etc.

As another modification, an additional passive radiator may be installed in the top or bottom of the internal enclosure as well as the side of the internal enclosure. In this case, the passive radiator installed in the top or bottom of the internal enclosure may have the same resonance condition as the passive radiator installed in the side of the internal enclosure or a resonance condition different from the resonance condition of the passive radiator installed in the side of the internal enclosure. When two sets of passive radiators are installed in both sides and top and bottom of the internal enclosure in this manner, it is preferable to form low sound radiating holes in the top, bottom, left and right sides of the front face of the internal enclosure.

In addition, an additional driver may be installed in the front face of the internal enclosure and installation places thereof may be combined in various ways. For example, two drivers may be located in the upper portion of the front face of the internal enclosure and low sound radiating holes may be located in both side of the lower portion thereof such that an output sound wave from the passive radiators can be emitted. Alternatively, one of the two drivers may be located in the upper portion of the front face of the internal enclosure, the other may be located in the lower portion thereof, and the low sound radiating holes through which the output sound wave from the passive radiators is emitted may be located in both sides of the central portion thereof.

In the meantime, according to an embodiment of the present invention, a characteristic of output sound may be changed by changing a volume of the internal enclosure. That is, a volume of an inner space of the internal enclosure may be easily changed by disposing a bottom-raised box part having a predetermined volume in the inner space of the internal enclosure, which results in a high degree of freedom of design for performance of speaker systems.

In addition, electrical signals input to the driver are processed to allow the speaker system constructed according to the embodiment of the present invention to show the optimal performance.

In particular, in the present invention, a gain limiting filter is used to lower a gain of a sound signal level in a range of frequency below a first resonance frequency.

In addition, in the present invention, a gain emphasizing filter is used to raise a gain of a sound signal level in a range of frequency above a second resonance frequency.

Thus, a sound reproduction characteristic in each frequency band signal is improved. In this case, a gain automatic adjusting filter is used to automatically limit a gain of the gain emphasizing filter such that an output amplitude of the gain emphasizing filter does not exceed a preset allowable dynamic range.

In the meantime, the speaker system of the present invention may be mounted within or connected to any types of electronic apparatuses which output audio signals, including a TV, a car audio unit, a computer audio unit, a DVD player, a projector, etc.

In particular, when the speaker system of the present invention is installed in a vehicle, the structural characteristic of the speaker system can prevent chattering noise of structures around the speaker from being generated and sound from leaked output the vehicle. In addition, the speaker system of the present invention is installed in an LCD TV, there occurs no problem of an adverse effect of vibration of a liquid crystal panel on pictures.

Hereinafter, preferred embodiments of the present invention will be described in detail with reference to the accompanying drawings. In the following detailed description of the present invention, concrete description on related functions or constructions will be omitted if it is deemed that the functions and/or constructions may unnecessarily obscure the gist of the present invention.

Prior to the description about embodiments of the present invention, terms used in the present invention are defined as follows. A ‘speaker system” is defined as an apparatus which includes an internal enclosure, a driver and so on and converts an electrical signal into sound to be output. The speaker system may be stand-alone or mounted within or connected to other apparatuses (for example, a vehicle, a TV, a sound system, etc.).

An ‘internal enclosure’ is also called a cabinet or a case and has an internal space. At least one driver, passive radiator and so on are installed in the internal enclosure, with their front faces directing to the outside, to form an external appearance of the speaker system. A ‘driver’ is also called a speaker unit and includes a magnetic circuit, a diaphragm, a frame and so on. The driver converts an input electrical signal transmitted from a signal processor into a sound signal by means of vibration of the diaphragm.

A ‘passive radiator’ refers to a passive resonant membrane and mainly emits low sound energy when being vibrated with driver vibration received through internal air of the internal enclosure.

An ‘external enclosure’ refers to an external case surrounding a portion of the internal enclosure. In the present invention, the external enclosure surrounds an installation portion of the passive radiator of the internal enclosure. In this case, a space (gap) through which sound output from the passive radiator passes is formed between the external enclosure and the internal enclosure. In addition, as described above, the external enclosure and low sound radiating hole are formed in the front face of the internal enclosure so that the sound output from the passive radiator can be emitted toward the front face of the speaker system. Accordingly, as the rear face of the internal enclosure contacts the external enclosure, the sound output from the passive radiator can be prevented from being emitted toward the rear face of the speaker system.

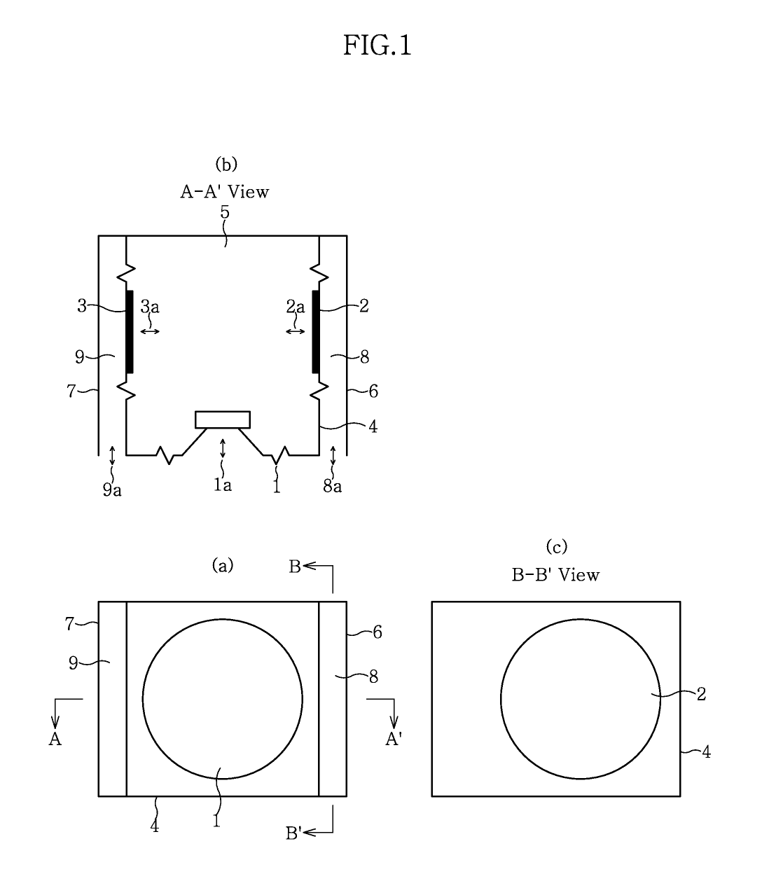

First, a structure of the speaker system according to first to ninth embodiments of the present invention will described with reference to FIGS. 1 to 9. Thereafter, results of experiments on a sound output characteristic of the speaker system manufacture according to the embodiments of the present invention will be described with graphs.

FIG. 1 shows an embodiment of the present invention. This figure shows that a driver is circular, a pair of circular passive radiators is placed in {the opposing left and right sides of the enclosure}, and low sound energy is emitted from the left and right sides of the speaker system. FIG. 1a is a front view, FIG. 1b is a sectional view taken along line A-A′, and FIG. 1c is a sectional view taken along line B-B′.

Reference numeral 1 denotes a driver having a circular radiating surface, {2 and 3} denote a pair of {first and second} passive radiators. 4 denotes a {sealed internal enclosure} in which the driver and the passive radiator are installed, 5 denotes an inner space, {6 and 7} denote an external enclosure for guiding sound energy emitted from the {first and second} passive radiators to the front face of the speaker system, {8 and 9} denote a space between the {first and second} passive radiators and the external enclosure, (2a and 3a) denote a vibration direction of the {first and second} passive radiators, and {8a and 9a} denote an emission direction of sound energy emitted from the {first and second} passive radiators into an external space.

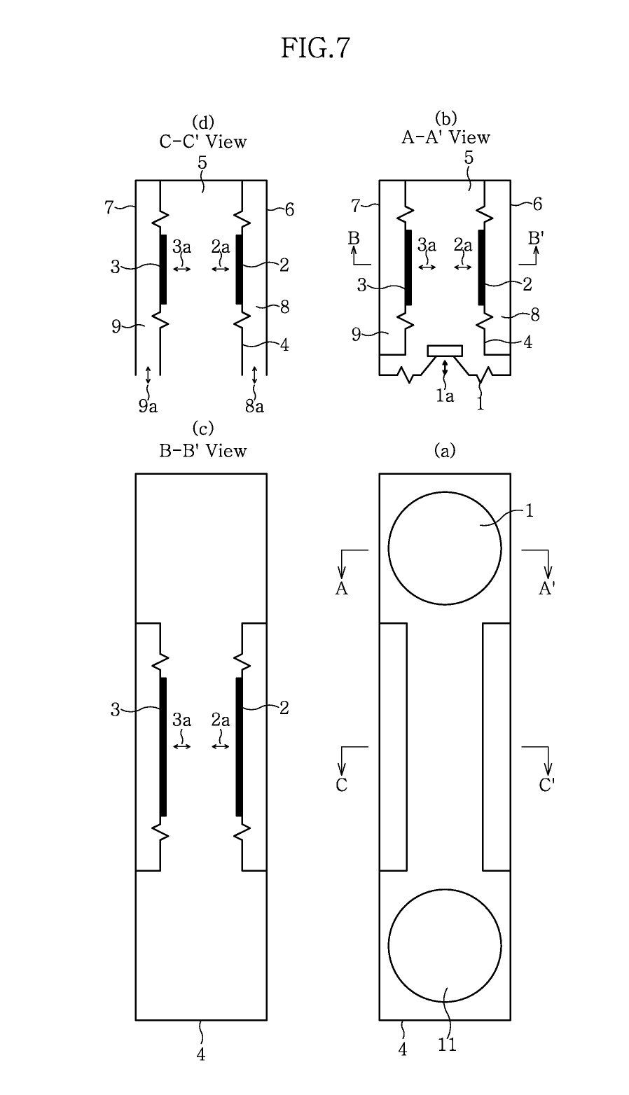

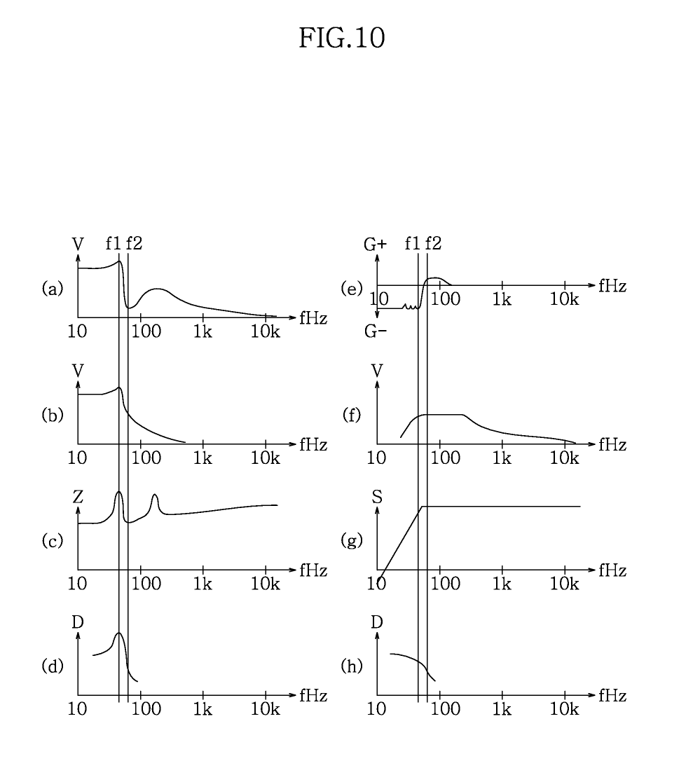

The embodiment of the present invention shown in FIG. 1 has low sound reproduction capability but not a low sound reproduction characteristic. FIG. 1 shows a speaker system having {first and second resonance points} shown in FIG. 7, with attributes of the {{the driver 1}, {passive radiators 2 and 3}, {internal enclosure 4} and {inner space 5}} as main elements. Theoretical explanation about the low sound reproduction capability of the speaker system is shown in FIG. 10.

The {external enclosure 6 and 7} {guides the sound energy generated by the vibration 2a and 3a of the passive radiators to the front face 8a and 9a of the speaker system}. An important factor is a {gap of {0.5 mm to 1 mm or so} between the {external enclosure and internal enclosure}, which serve as low sound radiating holes}. That is, it is very simple to hide {unattractive passive radiators} from the outside. Since the external enclosure guides the low sound energy to the front face, the sound will not be leaked out of the speaker system.

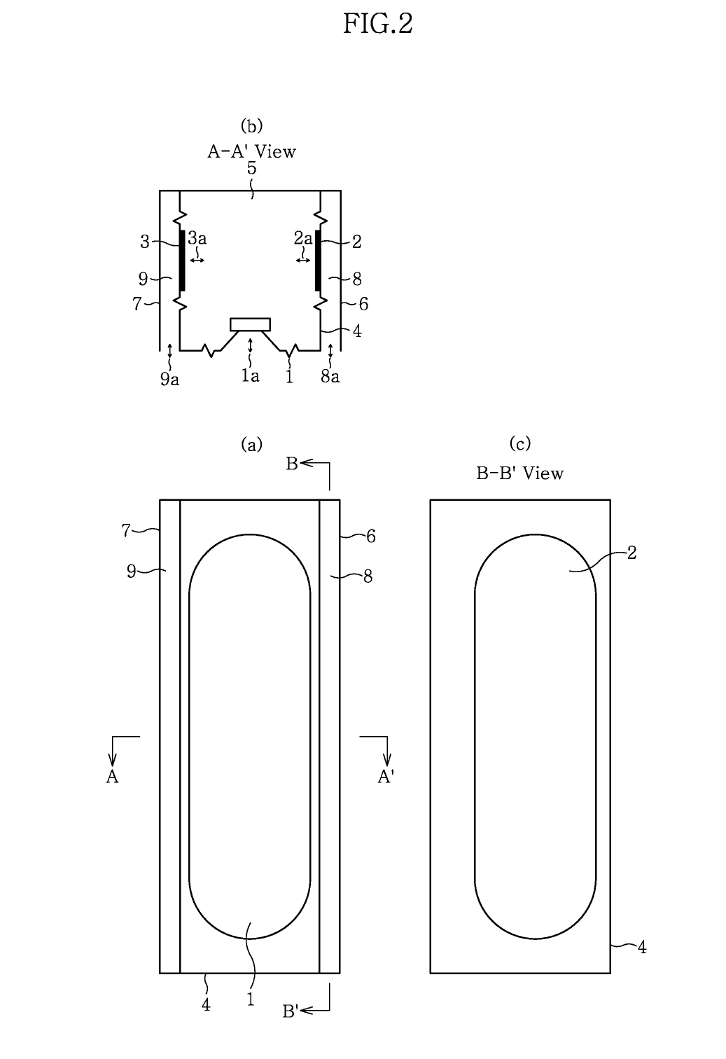

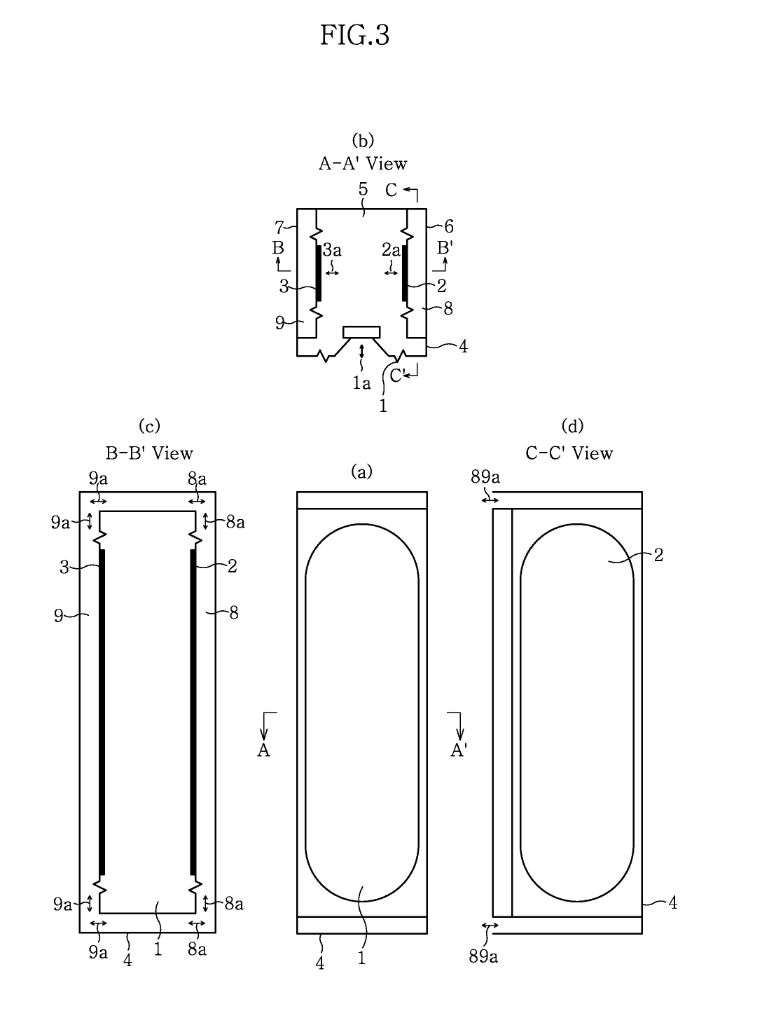

FIG. 2 shows an embodiment of the present invention. This figure shows that a driver is elliptical, a pair of elliptical passive radiators is placed in {the opposing left and right sides of the enclosure}, and low sound energy is emitted from the left and right sides of the speaker system. FIG. 2a is a front view, FIG. 2b is a sectional view taken along line A-A′, and FIG. 2c is a sectional view taken along line B-B′. The same reference numerals as FIG. 1 have the same functions and therefore, explanation thereof will not be repeated.

FIG. 3 shows an embodiment of the present invention. This figure shows that a driver is elliptical, a pair of elliptical passive radiators is placed in {the opposing left and right sides of the enclosure}, and low sound energy is emitted from the top and bottom sides of the speaker system. FIG. 3a is a front view, FIG. 3b is a sectional view taken along line A-A′, FIG. 3c is a sectional view taken along line B-B′, and FIG. 3d is a sectional view taken along line C-C′.

Reference numeral 1 denotes a driver having an elliptical radiating surface, 1a denotes a vibration direction of the driver, {2 and 3} denote {first and second} passive radiators, respectively, 4 denotes a {sealed internal enclosure} in which the driver and the passive radiator are installed, 5 denotes an inner space, {6 and 7} denote an external enclosure for guiding sound energy emitted from the {first and second} passive radiators to the front face of the speaker system, {8 and 9} denote a space between the {first and second} passive radiators and the external enclosure, (2a and 3a) denote a vibration direction of the {first and second} passive radiators, {8a and 9a} denote an emission direction of {sound energy emitted from the {first and second} passive radiators} into an external space, and {89a} denotes an emission direction of {combined sound energy emitted from the {first and second} passive radiators}. The same reference numerals as FIG. 1 have the same functions and therefore, explanation thereof will not be repeated.

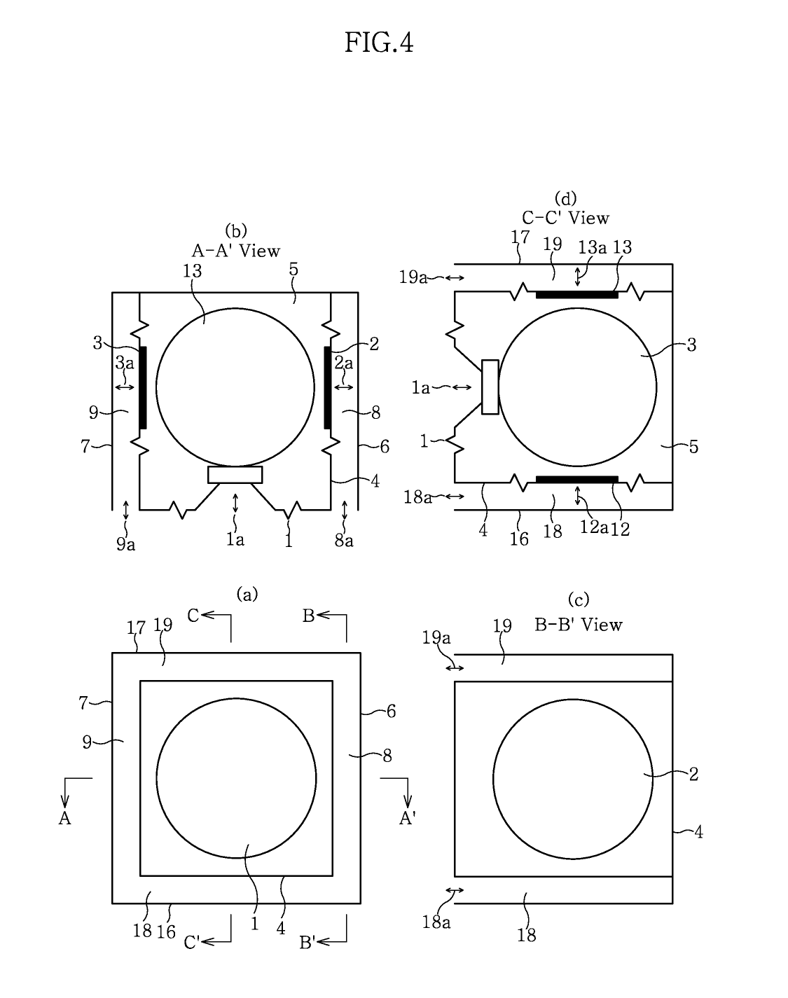

FIG. 4 shows an embodiment of the present invention. This figure shows that a driver is circular, two pairs of circular passive radiators are placed in {the opposing left, right, top and bottom sides of the enclosure}, and low sound energy is emitted from the left, right, top and bottom sides of the speaker system. The two pairs of passive radiators allow increase of a radiation area of the low sound hence increase of a low sound reproduction capability. The embodiment of the present invention shown in FIG. 4 has low sound reproduction capability but not a low sound reproduction characteristic.

FIG. 4a is a front view, FIG. 4b is a sectional view taken along line A-A′, FIG. 4c is a sectional view taken along line B-B′, and FIG. 4d is a sectional view taken along line C-C′.

Reference numeral 1 denotes a driver having a circular radiating surface, 1a denotes a vibration direction of the driver, {2, 3, 12 and 13} denote {first, second, third and fourth} passive radiators, respectively, 4 denotes a {sealed internal enclosure} in which the driver and the passive radiator are installed, 5 denotes an inner space, {6, 7, 16 and 17} denote an external enclosure for guiding sound energy emitted from the {first, second, third and fourth} passive radiators to the front face of the speaker system, {8, 9, 18 and 19} denote a space between the {first, second, third and fourth} passive radiators and the external enclosure, (2a, 3a, 12a and 13a) denote a vibration direction of the {first, second, third and fourth} passive radiators, and {8a, 9a, 18a and 19a} denote an {emission direction of sound energy emitted from the {first, second, third and fourth } passive radiators}.

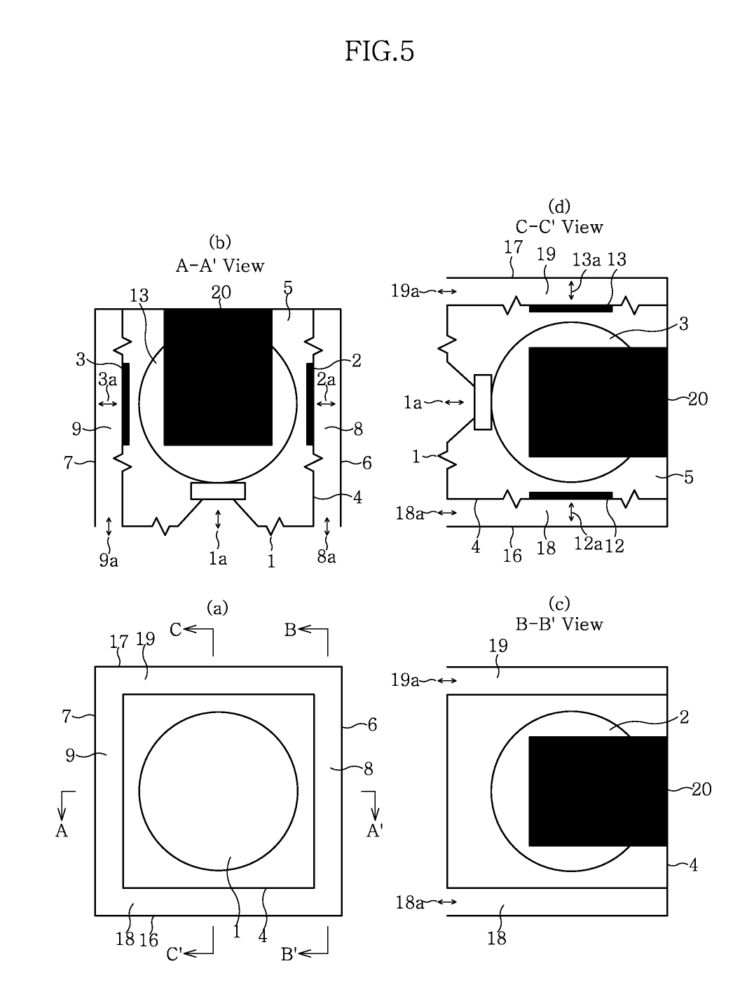

FIG. 5 shows an embodiment of the present invention. The same reference numerals as FIG. 4 have the same functions. The embodiment of FIG. 5 is different from the embodiment of FIG. 4 in that a bottom-raised box part 20 is added. The bottom-raised box part is used to decrease a volume of the inner space without changing an external appearance design. The decrease of the inner space increases frequencies of {first and second} resonance points. The easy change of the resonance points is a factor important in adjusting the capability of the speaker system. The bottom-raised box part is a part installed in a portion of the internal enclosure or in the bottom of the internal enclosure.

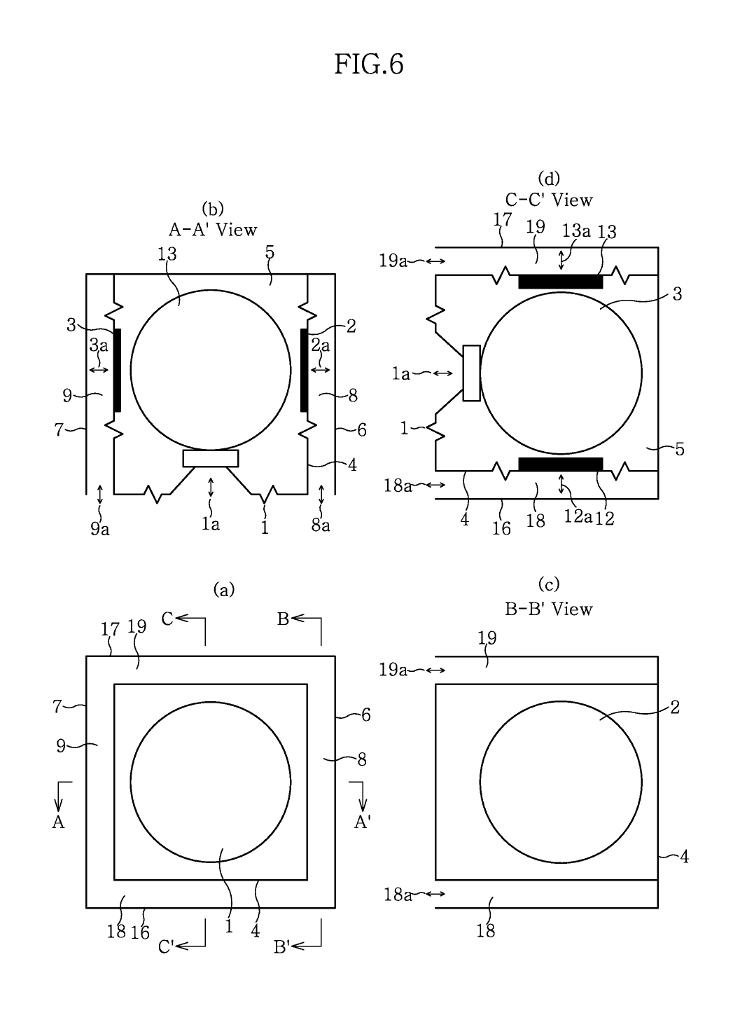

FIG. 6 shows an embodiment of the present invention. The same reference numerals as FIG. 4 have the same functions. The embodiment of FIG. 6 is different from the embodiment of FIG. 4 in that dimensions of two pairs of passive radiators are different. In FIG. 6, different dimensions of the passive radiators are indicated by a difference in thickness between the passive radiators. That is, referring to FIGS. 6b and 6d, the second passive radiators 12 and 13 are thicker than the first passive radiators 2 and 3.

By {finely adjusting the resonance condition of each pair of passive radiators}, the {capability of the speaker system} can be further improved. One pair of passive radiators has {first and second resonance points}. The first resonance point provides a maximal vibration amplitude of the driver and second resonance point provides a minimal vibration amplitude of the driver, which are used to adjust the entire reproduction capability of the speaker system.

For example, {adjustment of the second resonance point of one pair of passive radiators to f₀ of the driver} can {prevent unnecessary vibration near f₀} and {prevent sudden reduction of reproduction capability at a frequency lower than f₀}. This may result in {uniformity of reproduction capability of the speaker system in a frequency range below f₀} near f₀ of the driver. Another low sound reproduction capability is added under the resonance condition of the other pair of passive radiators. In this manner, the use of the plurality pairs of passive radiators facilitates a design of a speaker system having powerful reproduction capability.

FIG. 7 shows an embodiment of the present invention. This figure shows two {left and right} circular drivers for {left and right channels), respectively. In the figure, the drivers are shown to be vertically located but may be horizontally located in actual use. This figure shows that a pair of elliptical passive radiators is placed in {the opposing left and right sides of the enclosure), and combined left and right {low sound energy} is emitted from {the left and right sides of the speaker system}.

The embodiment of the present invention shown in FIG. 7 has low sound reproduction capability but not a low sound reproduction characteristic.

FIG. 7a is a front view, FIG. 7b is a sectional view taken along line A-A′, FIG. 7c is a sectional view taken along line B-B° and FIG. 7d is a sectional view taken along line C-C′.

{Reference numerals 1 and 11} denotes {drivers having a circular radiating surface} for {right and left channels), respectively, 1a denotes a vibration direction of the drivers, {2 and 3} denote {first and second) elliptical passive radiators, respectively, 4 denotes a sealed internal enclosure in which the drivers and the passive radiators are installed, 5 denotes an inner space, {6 and 7} denote an external enclosure for guiding sound energy emitted from the {first and second} passive radiators to the front face of the speaker system, {8 and 9} denote a space between the {first and second) passive radiators and the external enclosure, (2a and 3a) denote a vibration direction of the {first and second) passive radiators, and {8a and 9a} denote an emission direction of {sound energy emitted from the {first and second} passive radiators}.

In general, a user is insensitive to a low sound stereo effect. In particular, a compact speaker system provide a small low sound stereo feeling if a gap between left and right drivers is small. In many cases, such a speaker system produces a monaural sound by combining left and right low sound. Even in a large-sized speaker system, a woofer is often composed of left and right combined monaural. FIG. 7 shows an embodiment for such a case.

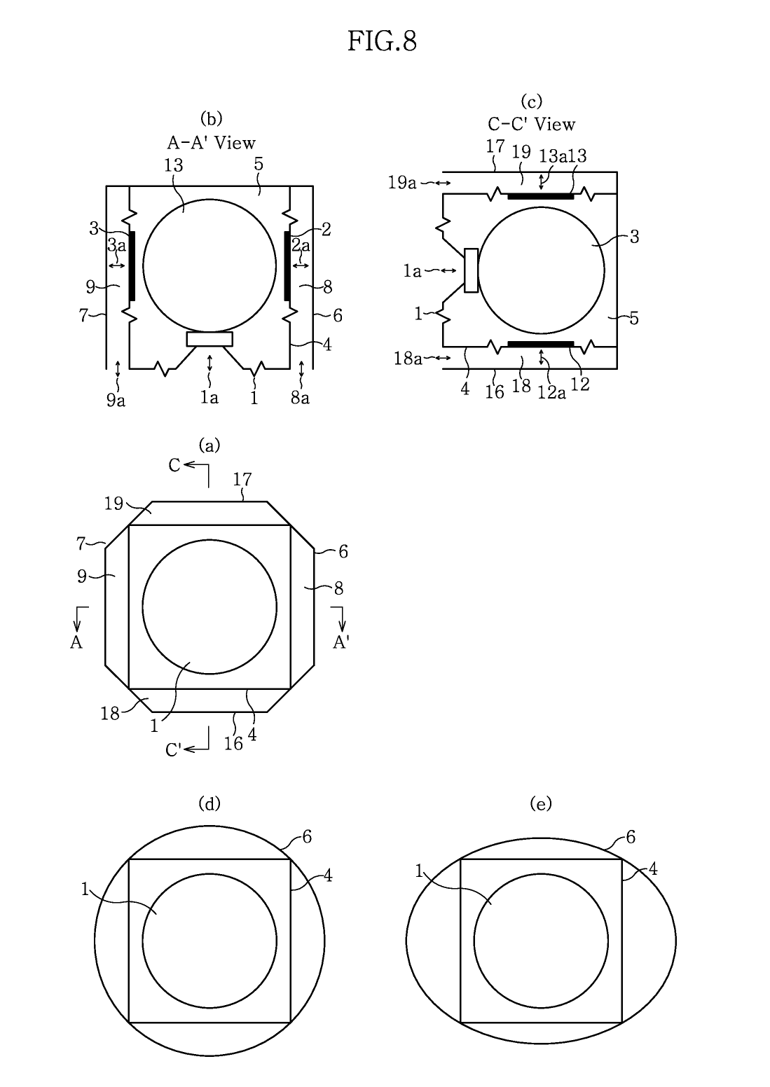

FIG. 8 shows an embodiment of the present invention. This embodiment has the same basic structure as the speaker system of FIG. 4 having four passive radiators and includes an external enclosure which is octagonal, circular or elliptical. The embodiment of the present invention shown in FIG. 8 has low sound reproduction capability but not a low sound reproduction characteristic.

FIG. 8a is a front view of an octagonal external enclosure, FIG. 8b is a sectional view taken along line A-A′, FIG. 8c is a sectional view taken along line C-C′ in FIG. 8b, FIG. 8d is a front view of a circular external enclosure, and FIG. 8e is a front view of an elliptical external enclosure.

The embodiment of FIG. 8 has the same acoustic function as the embodiment of FIG. 4, and the same reference numerals as FIG. 4 has the same functions. By making four corners of the external enclosure planar to provide an octagonal external enclosure, an occupation volume of the speaker system can be reduced. A lesser occupation volume is important for a design of the speaker system. In addition, an {action of four corner of the internal enclosure to expand an inner face of the external enclosure} serves to {reinforce the external enclosure against low sound vibration}. A circular or elliptical external enclosure provides the same effect as the octagonal external enclosure.

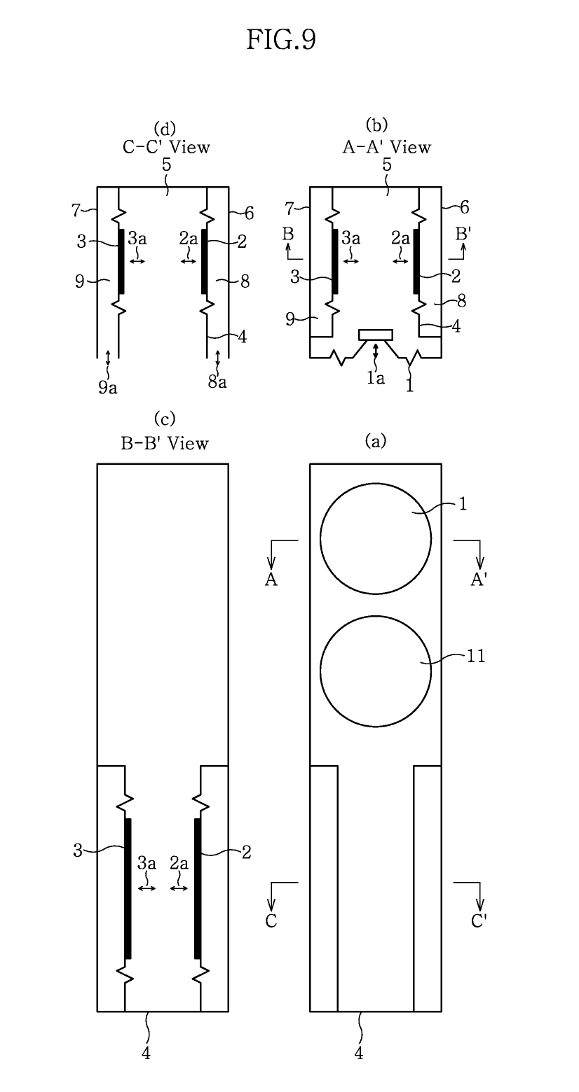

FIG. 9 shows an embodiment of the present invention. As shown in FIG. 9a, a major axis lies in a vertical direction but may lie in a horizontal direction depending on use conditions. This embodiment is a modification of FIG. 7 where the second driver 11 is placed immediately below the first driver 1 and one pair of elliptical passive radiators 2 and 3 is placed below the second driver 11 in the opposing left and right sides of the internal enclosure 4 such that left and right combined low sound energy is emitted from the left and right sides of the front face of the speaker system.

FIG. 9a is a front view, FIG. 9b is a sectional view taken along line A-A′, FIG. 9c is a sectional view taken along line B-B′ in FIG. 9b, and FIG. 9d is a sectional view taken along line C-C′ in FIG. 9a. The same reference numerals as FIG. 7 have the same functions.

FIG. 10 shows mechanical and electrical characteristics of various elements of an embodiment of the present invention. This figure illustrates a specific example where a combination of the {speaker system of any of the embodiments of FIGS. 1 to 9} and {signal processing} allows {{suppression of demerits and drawing of merits} of the speaker system}, which may result in construction of a compact and high performance sound reproduction system.

A horizontal axis f represents a frequency, a vertical axis V represents a vibration amplitude, a vertical axis Z represents an impedance, a vertical axis D represents a distortion, a vertical axis G represents a gain and a vertical axis S represents a sound intensity.

f1 represents a first resonance frequency and f2 represents a second resonance frequency. At the first resonance frequency, the {driver and passive radiator} have a {substantial anti-phase relationship in a sound field} and a {substantial in-phase relationship in vibration}. Although the first resonance point is evaluated in many aspects, the present invention designs dimensions of various elements based on the point of view that {{an effect by resonance of the pair of passive radiators on the driver} is a mode to {strengthen vibration of the driver}}.

Since {{a sound emitted from the driver and a sound emitted from the passive radiators have a cancellation relationship} near the first resonance frequency}, fundamental waves are lessened, leaving high frequency components, thereby producing a highly-distorted reproduction sound.

Since {energy emitted from the passive radiators} can be increased over {energy emitted from the driver} depending on a design method of the first resonance condition, only distortion components are not necessarily left. However, by using a small driver to {increase an emission efficiency of low sound energy in this manner}, {a distortion due to an insufficient dynamic range which is a weak point of the small driver} is typically increased at the first resonance point.

At the second resonance point, the river and the passive radiator have a {substantial in-phase relationship in a sound field} and a {substantial anti-phase relationship in vibration}. In addition, in a vibration mode where the driver compresses (expands) internal air of the internal enclosure, the passive radiators also enter a mode where they compress (expand) the internal air of the enclosure like the driver. That is, at the second resonance point, since the {vibration of the passive radiators vibrated according to the vibration of the driver} is a {reaction against the driver}, an amplitude of the driver is lessened.

In addition, at the second resonance point, a vibration amplitude of an air pressure of the internal enclosure becomes maximal and a {transfer efficiency of vibration energy from the driver to the passive radiators} is increased. Since {electrical impedance of the driver at the second resonance point} becomes minimal and {a load applied to the driver is increased}, a {transfer efficiency of power from the driver to the passive radiators} is increased.

This has an important meaning when a small driver reproduces low sound. That is, this means that {the commonsensical characteristic that a driver having a small diameter provides a (small reaction of emission of sound energy} and consequently {a load of a voice coil is light}} can be {improved as {a characteristic as if a diaphragm having a large diameter is installed} or {a characteristic as if a driving force of a voice coil is increased to increase a vibration amplitude}}. Further, {decrease of the vibration amplitude of the driver} leads to {significant improvement of a dynamic range of low sound reproduction}. In addition, even a small speaker can have a low-distorted powerful low sound reproduction capability.

Although it is difficult to design the first and second resonance points independently, a {frequency band including both of the first and second resonance points} can be freely designed by changing {three parameters, i.e., {a volume of the internal enclosure}, {a surface area of the passive radiators} and {a weight of the passive radiators}} based on an attribute of the driver. Nevertheless, the speaker system of the present invention has {only a low sound reproduction capability} but not a low sound reproduction characteristic. A role of the following signal processing of the present invention is to {{provide a low sound reproduction characteristic} {by drawing this low sound reproduction capability}}.

At the first resonance point, {the pair of the driver and the passive radiator} is likely to generate distortion as well as unstable vibration introducing a parasitic local resonance. This parasitic resonance has a troublesome property that {if {the pair of the driver and the passive radiator is triggered under any condition to enter a parasitic resonance region a little}, {the pair enters the parasitic resonance region} and {the parasitic resonance is grown to a large amplitude parasitic resonance which may not be suppressed}}. An even troublesome problem is that {a condition to obtain a more efficient sound characteristic is more likely to generate this parasitic resonance}.

In general, this parasitic resonance is often {generated at a fraction of a frequency near the first resonance frequency} due to {mechanical {asymmetry and non-linearity} of the passive radiators}. Once the parasitic resonance is generated, the parasitic resonance grows to its maximum amplitude. This effect is due to self-induced vibration generated by absorption of the parasitic resonance as a result of {increase of {asymmetry and non-linearity} as amplitude of the parasitic resonance exceeds a limit}. A source of energy of the parasitic is vibration near the first resonance frequency.

Thus, a means very effective in suppressing this parasitic resonance is to {{design the speaker system such that the first resonance frequency falls within {a frequency band which need not be reproduced by the speaker system}} and to provide {signal processing capability to cut off {the vicinity of the first resonance frequency} and {a frequency band below the vicinity of the first resonance frequency}}. In addition, another very effective means is {adequate suppression of a gain} required for {suppression of {distortion and parasitic resonance}} although they cannot be completely cut off.

In this manner, the passive radiator type speaker system is recycled into a {speaker system having a miraculous low sound reproduction characteristic} in combination with {signal processing for {suppression of demerits and drawing of merits} of the speaker system} although this system is compact.

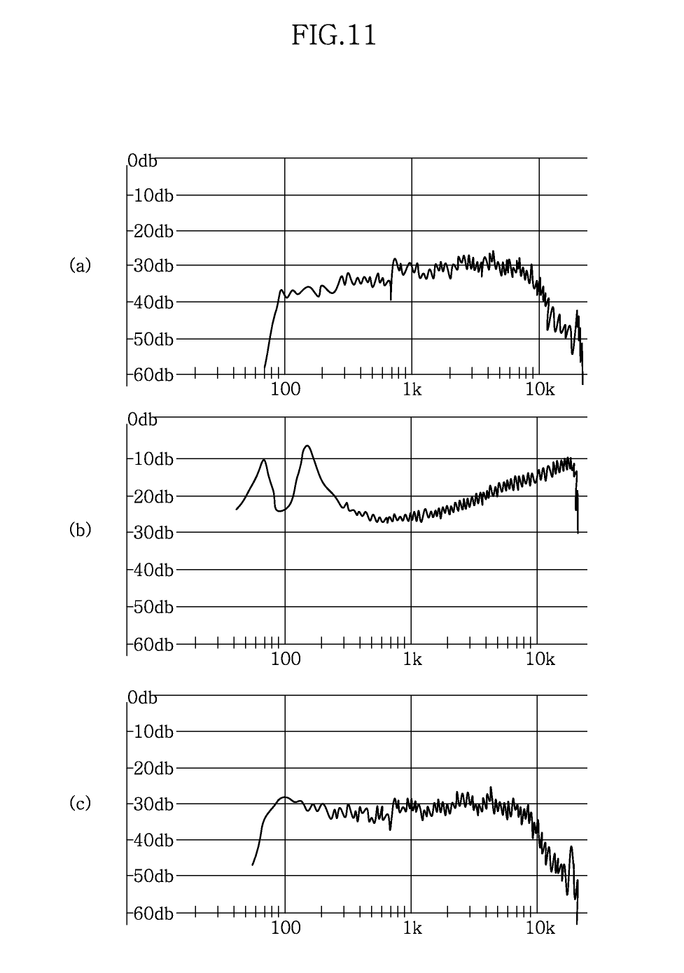

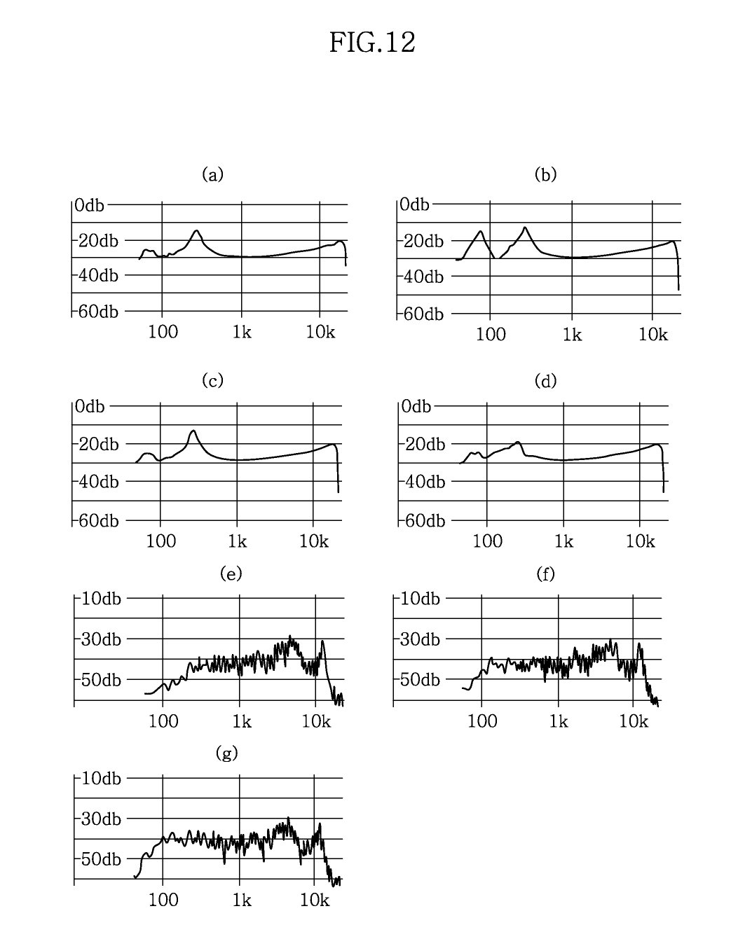

As will be described later, FIG. 11 shows a characteristic of an {actual sample of the present invention {using a 2-inch driver} for {the practical octagonal enclosure shown in FIG. 8}} and FIG. 12 shows a characteristic of an {actual sample of the present invention {using a 1.5-inch driver} for {the practical octagonal enclosure shown in FIG. 8}}.

FIG. 10a is an explanatory view for a {frequency characteristic of vibration amplitude} of a {diaphragm of the driver} of the {speaker system of the present invention}. FIG. 10b is an explanatory view for a {frequency characteristic of vibration amplitude} of the {passive radiators} of the {speaker system of the present invention}. FIG. 10c is an explanatory view for a {frequency characteristic of electrical impedance} of a {voice coil of the driver} of the {speaker system of the present invention}. FIG. 10d is an explanatory view for a {frequency characteristic of distortion of reproduced sound} of the {speaker system of the present invention}. FIG. 10e is an explanatory view for an {example signal processing characteristic} which is {optimal for the speaker system of the present invention}. FIG. 10f is an explanatory view for a {frequency characteristic of vibration amplitude} of a {diaphragm of the driver} when the signal processing characteristic of FIG. 10e is applied. FIG. 10g is an explanatory view for a {frequency characteristic of reproduced sound pressure} when the signal processing characteristic of FIG. 10e is applied. FIG. 10h is an explanatory view for a {distortion characteristic of reproduced sound pressure} by the {speaker system and optimal signal processing function} of the present invention.

FIG. 11 shows a characteristic of an actual sample of an embodiment} of the present invention. Specifically, this figure shows a characteristic of an actual sample of the present invention with a combination of a speaker system of the embodiment of FIG. 8 having the following dimensions: {{the octagonal external enclosure: 68 mm in length, 71 mm in depth}, {the internal enclosure: 61 mm in length, 71 mm in depth}, {a gap between the external enclosure and the internal enclosure: 1 mm}, {a 10 W driver: 2 inches in diameter}, {two pairs of passive radiators), and {total weight: 250 Gw}}, and {{the signal processing optimal for the speaker system} shown in FIG. 10}.

FIG. 11a shows a frequency characteristic of a sound pressure of the speaker system, FIG. 11b shows a frequency characteristic of electrical impedance of the speaker system, and FIG. 11c shows a frequency characteristic of a sound pressure in combination of the speaker system with the signal processing.

FIG. 11 shows a very wide low sound reproduction characteristic for the 2-inch driver that a {characteristic that a {limit of low sound reproduction range is 100 Hz} and {a sound pressure slowly decreases with a change from a middle and low sound range to a low frequency} before the signal processing} is changed to a {characteristic that a {limit of low sound reproduction range is expanded to 65 Hz} and {a sound pressure slowly increases with a change from a middle and low sound range to a low frequency} after the signal processing).

FIG. 12 shows a characteristic of an {actual sample of an embodiment} of the present invention. Specifically, this figure shows a characteristic of an actual sample of the present invention with a speaker system of the embodiment of FIG. 8 having the following dimensions: {{the octagonal external enclosure: 60 mm in length, 63 mm in depth}, {the internal enclosure: 53 mm in length, 63 mm in depth}, {a gap between the external enclosure and the internal enclosure: 1 mm}, {a 5 W driver: 1.5 inches in diameter}, {two pairs of passive radiators}, and {total weight: 250 Gw}}. This figure also shows a {result of measurement of a characteristic} of the actual sample of the present invention with the combination of the speaker system with the {{signal processing optimal to the speaker system} shown in FIG. 10} in order to significantly improve low sound reproduction capability by {adjusting a volume of the internal enclosure using the method shown in FIG. 5} and {adjusting the resonance conditions of the two pairs of passive radiators using the method shown in FIG. 6}.

FIGS. 12a and 12c show a {frequency characteristic of electrical impedance} of the speaker system with {the same resonance conditions of the two pairs of passive radiators shown in FIG. 6} without employing the method of adjusting the volume of the internal enclosure shown in FIG. 5. In this case, it can be seen that a frequency characteristic of impedance is weak at the first and second resonance points due to a small diameter of the driver.

FIG. 12b shows a {frequency characteristic of electrical impedance} of the speaker system when the resonance characteristic at the first resonance point is more sharpened by employing the {method of adjusting the volume of the internal enclosure shown in FIG. 5} and the {method of adjusting the weight of the pairs of passive radiators shown in FIG. 6}. In this case, it can be seen that the characteristic of the first resonance point is more sharpened by decreasing the volume of the internal enclosure and increasing the weight of the pairs of passive radiators.

FIG. 12d shows a characteristic of electrical impedance of the speaker system when {size and weight of one pair of passive radiators shown in FIG. 6 are changed and {the second resonance frequency is adjusted to a {resonance frequency f₀ of the driver}}. In this case, it can be seen that a characteristic near the resonance frequency f₀ of the driver is not sharpened by adjusting the second frequency point of one of the two pairs of passive radiators to the resonance frequency f₀ of the driver.

FIG. 12e shows a {frequency characteristic of reproduced sound pressure of the speaker system {without employing the method of adjusting the volume of the internal enclosure shown in FIG. 5} and {without adjusting the resonance conditions of the two pairs of passive radiators shown in FIG. 6}.

FIG. 12f shows a {frequency characteristic of reproduced sound pressure of the speaker system} when a {volume of an inner space is adjusted by the bottom-raised box part shown in FIG. 5}, {weight of one pair of passive radiators shown in FIG. 6 is adjusted and {the second resonance frequency is adjusted to the {resonance frequency f₀ of the driver}}.

FIG. 12g shows a {frequency characteristic of reproduced sound pressure of the speaker system} in combination of the speaker system with the signal processing. It can be here seen that this combination can achieve a low sound reproduction characteristic of a {sound range which cannot be achieved} by {conventional methods using a 1.5-inch driver}.

Hitherto, the structure of the speaker system of the embodiments of the present invention and the characteristics according to the signal processing have been illustrated. The speaker system of the embodiments of the present invention can be utilized as follows:

1. Application to a compact speaker system with good low sound reproduction capability.

2. A speaker system for LCD TV requiring high performance sound reproduction capability.

3. A car speaker system which has to find a compromise with low sound reproduction capability due to chattering noise caused by vibration of window panes and internal structures of doors although the system needs powerful low sound reproduction capability.

4. A car speaker system which significantly suppresses reproduced sound leaked out of a car in reproducing the low sound by eliminating reproduced sound leaked out of a space between an inner panel and an outer panel of the car.

While the specific embodiments of the present invention have been illustrated in the above, it should be understood that various modifications may be made without departing from the spirit and scope of the invention. Therefore, the scope of the invention is not intended to be limited to the disclosed embodiments but should be defined by only the appended claims and its equivalents.

### INDUSTRIAL APPLICABILITY

The present invention provides a group of speaker systems with {performance and dimensions} standardized in the industry.

What is claimed is:

1. A speaker system in which:
a speaker unit to convert electrical energy into vibration energy is defined as a driver,
a {{diaphragm different from the driver} to receive the vibration energy of the driver and {strengthen emission efficiency of low sound}} is defined as a passive radiator,
two sets of opposing passive radiators are defined as pairs of passive radiators,
a {sealed box} to {deliver vibration of the driver to the passive radiators through air vibration} is defined as an internal enclosure,
a {sealed space defined by the driver, the passive radiators and the internal enclosure} is defined as an inner space,
a sound energy emission surface of the driver is defined as a front face,
an {enclosure to {guide emission sound energy of the passive radiators to the front face}, which is installed in the outside of the internal enclosure} is defined as an external enclosure,
a {{front face gap} formed between the internal enclosure and the external enclosure} is defined as a low sound radiating hole,
including {one or more drivers}, {one or two pairs of passive radiators}, {the internal enclosure} and the external enclosure} is defined as a first characteristic,
arranging {emission surface of the driver and emission surface of the pair of passive radiators} {perpendicular to each other or in parallel to each other} is defined as a second characteristic, and
operating the external enclosure such that {emission energy of the passive radiators} is emitted from the low sound radiating hole is defined as a third characteristic,
wherein the speaker system includes the first to third characteristics.

2. The speaker system according to claim 1, wherein {the internal enclosure and the external enclosure} are parts independently of each other,
the speaker system including a fourth characteristic defined by a {structure to emit low sound energy emitted by the passive radiators from the low sound radiating hole} through {the gap formed between the internal enclosure and the external enclosure} by inserting the internal enclosure in the external enclosure.

3. The speaker system according to claim 1, wherein:
making an {outer shape of the external enclosure viewed from the front face} octagonal and lessening a total volume of the speaker system as compared to a speaker system employing a rectangular external enclosure is defined as a fifth characteristic,
making {four of eight faces of the octagonal external enclosure} and {four faces of the internal enclosure} parallel is defined as a sixth characteristic,
contacting {inner surfaces of the remaining four faces of the octagonal external enclosure} with {four corners of outer surfaces of the external enclosure} is defined as a seventh characteristic,
emitting {the low sound energy emitted by the passive radiators} from the low sound radiating hole is defined as an eighth characteristic, and
wherein the speaker system includes the fifth to eighth characteristics.

4. The speaker system according to claim 1, wherein:
making an {outer shape of the external enclosure viewed from the front face} {circular or elliptical} and lessening a total volume of the speaker system as compared to a speaker system employing a rectangular external enclosure is defined as a ninth characteristic,
contacting {inner surfaces of the octagonal external enclosure} with {four corners of outer surfaces of the internal enclosure} is defined as a tenth characteristic,
emitting {the low sound energy emitted by the passive radiators} from the low sound radiating hole is defined as an eleventh characteristic, and
wherein the speaker system includes the ninth to eleventh characteristics.

5. The speaker system according to claim 1, wherein:
a {structure installed to lessen a volume of the inner space} is defined as a bottom-raised box part,
setting a shape of the bottom of the internal enclosure to a bottom-raised box structure is defined as a twelfth characteristic,
installing a part to provide the bottom-raised box structure in the internal enclosure is defined as a thirteenth characteristic,
wherein the speaker system includes the twelfth or thirteenth characteristic.

6. The speaker system according to claim 1, wherein the speaker system includes two or more pairs of passive radiators, and
wherein the speaker system includes a fourteenth characteristic defined by {the two or more pairs of passive radiators} having different {emission areas and/or weights}.

7. A sound reproduction apparatus comprising:
a speaker system according to claim 1, wherein:
regarding {dimensions measurable by varying a frequency with a voltage applied to the driver among {main dimensions of the speaker system} which are determined in design specification of {the driver, the passive radiators, the internal enclosure and the external enclosure},
a {frequency providing the maximal vibration amplitude of the driver} in {a lower sound range} or a {frequency providing the maximal electrical impedance of the driver} in a {lower sound range} is defined as a first resonance point,
a {frequency providing the minimal vibration amplitude of the driver} when a frequency slowly increases from the first resonance point or a {frequency providing the minimal electrical impedance of the driver} when a frequency slowly increases from the first resonance point is defined as a second resonance point,
a signal processing function to lessen a {level of sound signal applied to the speaker system} at {the first resonance point frequency} and in a range of {frequency lower than the first resonance point} is defined as a first resonance point gain limiting filter,
a signal processing function to raise a {level of sound signal applied to the speaker system} in {a range of frequency near the second resonance point}, {a range of frequency higher than the second resonance point} and in {a range of low sound frequency} is defined as a second resonance point gain emphasizing filter, and
a function to automatically suppress a {gain of the second resonance point gain emphasizing filter} if an {output amplitude of the second resonance point gain emphasizing filter} is about {to be beyond an allowable dynamic range} is defined as a second resonance point gain automatic adjustment filter,
wherein the sound reproduction apparatus includes a fifteenth characteristic defined by inclusion of the {speaker system according to claim 1}, the {first resonance point gain limiting filter}, and the {{second resonance point gain emphasizing filter or {second resonance point gain automatic adjustment filter}}.

8. A television set comprising a speaker system according to claim 1.

9. A television set comprising a sound reproduction apparatus according to claim 7.

10. A car comprising a speaker system according to claim 1.

11. A car comprising a sound reproduction apparatus according to claim 7.

12. A speaker system comprising:
at least one driver which converts input electrical energy into vibration energy and emits a sound wave;
an internal enclosure in which the driver is installed in the front face and which forms a sealed space therein;
at least one pairs of passive radiators which is installed perpendicular to an emission surface of the driver and is vibrated by the vibration energy output from the driver to emit a sound wave; and
an external enclosure which forms a space in the front face of the passive radiators to cover the passive radiators and includes a low sound radiating hole formed in the front face of the internal enclosure such that a sound wave emitted from the passive radiators is guided to the front face of the internal enclosure through the formed space.
